(19) United States
(12) Patent Application Publication
(10) Pub. No.: US 2026/0325969 A1
(43) Pub. Date: Oct. 22, 2026

(54) GAME CONTROL METHOD AND APPARATUS, AND ELECTRONIC DEVICE AND STORAGE MEDIUM

(71) Applicant: NETEASE (HANGZHOU) NETWORK CO., LTD., Hangzhou, Zhejiang (CN)

(72) Inventor: Jingyi FU, Guangzhou, Guangdong (CN)

(73) Assignee: NETEASE (HANGZHOU) NETWORK CO., LTD., Hangzhou, Zhejiang (CN)

(21) Appl. No.: 19/103,473

(22) PCT Filed: Nov. 1, 2022
(86) PCT No.: PCT/CN2022/128977

§ 371 Date: Feb. 12, 2025

(30) Foreign Application Priority Data
Aug. 12, 2022 (CN) 202210968915.6

(51) Int. Cl. A63F 13/5372; A63F 13/56; A63F 13/837

(52) U.S. Cl. CPC A63F 13/5372; A63F 13/56; A63F 13/837

(57) ABSTRACT

Provided in the present disclosure are a game control method, an electronic device and a storage medium. The method includes: in response to the current virtual battle task meeting a preset condition, controlling the dropping of a virtual material in a virtual scene; determining a target scene area, which corresponds to the dropped virtual material, in the virtual scene; and in response to a virtual object moving into the target scene area, displaying an orientation guidance identifier on a graphical user interface, and controlling the pointing direction of the orientation guidance identifier according to a target position of the virtual material in the virtual scene.

### CROSS-REFERENCE TO RELATED APPLICATIONS

The present application is a U.S. National Stage of International Application No. PCT/CN2022/128977, filed on Nov. 1, 2022, which claims the benefit of priority to Chinese patent application number 202210968915.6, filed on Aug. 12, 2022, both of which are incorporated by reference herein in their entireties for all purposes.

### TECHNICAL FIELD

The present disclosure relates to the field of game technology, and in particular to a game control method, a game control device, an electronic device and a storage medium.

### BACKGROUND

In some shooting games, virtual vehicles (such as helicopters) drop airdrop supplies into virtual scenes along fixed routes and at fixed time intervals. After landing, the airdrop supplies will generate a special identifier in the virtual scene, and a location identifier corresponding to the location of the airdrop supplies in the virtual scene will also be generated on the scene thumbnail map. Players can find and loot the airdrops based on the location identifier and the special identifier in the virtual scene.

### SUMMARY

According to a first aspect of the present disclosure, there is provided a game control method, and the method includes:

providing, by a terminal device, a graphical user interface is provided through a terminal device, and displaying a virtual scene of a current virtual battle task on the graphical user interface;

in response to detecting that the current virtual battle task meets a preset condition, controlling to drop a virtual supply in the virtual scene;

determining a target scene area corresponding to the virtual supply dropped in the virtual scene; and

in response to detecting a virtual object moves into the target scene area, displaying an orientation guidance identifier on the graphical user interface, and controlling a direction indicator of the orientation guidance identifier according to a target position of the virtual supply in the virtual scene.

According to a second aspect of the present disclosure, there is provided an electronic device, where the electronic device includes: a processor, a memory and a bus, the memory stores machine-readable instructions executable by the processor, when the electronic device is running, the processor communicates with the memory through the bus, and the processor executes the machine-readable instructions to execute the steps of the game control method described above.

According to a third aspect of the present disclosure, there is provided a non-transitory computer-readable storage medium, where a computer program is stored on the computer-readable storage medium, and when the computer program is executed by the processor, the steps of the game control method described above is performed.

In order to make the above-mentioned objectives, features and advantages of the present disclosure more obvious and easy to understand, preferred embodiments are specifically cited below and described in detail with reference to the attached drawings.

### BRIEF DESCRIPTION OF THE DRAWINGS

In order to more clearly illustrate the technical solution of the embodiment of the present disclosure, the following will briefly introduce the drawings required for use in the embodiment. It should be understood that the following drawings only show certain embodiments of the present disclosure, and therefore should not be regarded as limiting the scope. For those skilled in the art, other relevant drawings can also be obtained based on these drawings without creative work.

FIG. 1 is a flow chart of a game control method provided by one or more embodiments of the present disclosure;

FIG. 2 is a schematic diagram of a graphical user interface provided by one or more embodiments of the present disclosure;

FIG. 3 is a flow chart of another game control method provided by one or more embodiments of the present disclosure;

FIG. 4 is a schematic diagram of another graphical user interface provided by one or more embodiments of the present disclosure;

FIG. 5 is a flow chart of another game control method provided by one or more embodiments of the present disclosure;

FIG. 6 is a structural schematic diagram of a game control device provided by one or more embodiments of the present disclosure;

FIG. 7 is a structural schematic diagram of another game control device provided by one or more embodiments of the present disclosure;

FIG. 8 is a structural schematic diagram of another game control device provided by one or more embodiments of the present disclosure;

FIG. 9 is a structural schematic diagram of an electronic device provided by one or more embodiments of the present disclosure.

### DETAILED DESCRIPTION

In order to make the purpose, technical solution and advantages of the embodiments of the present disclosure clearer, the technical solution in the embodiments of the present disclosure will be clearly and completely described below in conjunction with the drawings in the embodiments of the present disclosure. Obviously, the described embodiments are only part of the embodiments of the present disclosure, not all of the embodiments. The components of the embodiments of the present disclosure described and shown in the drawings here can be arranged and designed in various different configurations. Therefore, the following detailed description of the embodiments of the present disclosure provided in the drawings is not intended to limit the scope of the present disclosure claimed for protection, but only represents the selected embodiments of the present disclosure. Based on the embodiments of the present disclosure, each of other embodiments obtained by those skilled in the art without making creative work belongs to the scope of protection of the present disclosure.

First, the names involved in the embodiments of the present disclosure are briefly introduced:

### (1) Terminal Device

The terminal device involved in the embodiments of the present disclosure mainly refers to a terminal for providing a graphical user interface and capable of controlling virtual objects. The terminal device can be a local terminal device mentioned below, or a client device in a cloud interaction system. The terminal device may include but is not limited to any of the following devices: a laptop, a smart phone, a tablet computer, a desktop computer, a game console, an MP4 (Moving Picture Experts Group Audio Layer IV) player, a personal digital assistant (PDA), an e-book reader, etc. The terminal device installs and runs an application that supports games, such as an application that supports three-dimensional games or two-dimensional games. In the embodiments of the present disclosure, the application is introduced as a game application. In some embodiments, the application can be a stand-alone application, such as a stand-alone 3D game program, or a network-connected application.

### (2) Graphical User Interface

A graphical user interface is an interface display format for communication between a person and a computer, which allows a user to manipulate icons, logos or menu options on the screen using an input device such as a mouse or keyboard, and also allows a user to manipulate icons or menu options on the screen by performing touch operations on a touch screen of a touch terminal to select commands, start programs or perform other tasks.

The graphical user interface in the embodiments of the present disclosure can provide or display a screen corresponding to the application, which includes a UI interface for players to interact and a game screen. In an embodiment, the UI interface may include game controls (such as a skill control, a movement control, a function control, etc.), indicators (such as direction indicators, character indicators, etc.), information display areas (such as the number of kills, match time, etc.), or game setting controls (such as system settings, stores, gold coins, etc.). In an embodiment, the game screen is a display screen corresponding to the virtual scene displayed by the terminal device, and the game screen may include virtual objects such as game characters, NPC characters, and AI characters that execute game logic in the virtual scene.

### (3) Virtual Scene

The virtual scene is the game scene displayed (or provided) when the application is running on the terminal or server, that is, the scene used during the normal game process. In other words, the virtual scene refers to the virtual game controls that carry virtual objects during the game process. The virtual objects can move, release skills, and other actions in the game scene under the control of the operation instructions issued by the user (that is, the player) to the terminal device. In some embodiments, the game scene can be a simulation environment of the real world, a semi-simulation and semi-fictional virtual environment, or a purely fictional virtual environment. The game scene can be any one of a two-dimensional virtual scene, a 2.5-dimensional virtual scene and a three-dimensional virtual scene, and the virtual environment can be sky, land, ocean, etc., where the land includes environmental elements such as deserts and cities. The game scene is a scene in which the user controls the complete game logic of the virtual object. In some embodiments, the game scene can also be used for a game scene battle between at least two virtual objects, and there are virtual resources available for at least two virtual objects in the game scene. For example, the game scene can include any one or more of the following elements: game background elements, game object elements, game prop elements, and game material elements.

### (4) Virtual Object

A virtual object refers to a dynamic object that can be controlled in a virtual scene. In some embodiments, the dynamic object can be a virtual character, an anime character, etc. The virtual object is a character controlled by the player through an input device, or an artificial intelligence (AI) set in a virtual environment battle through training. In some embodiments, the virtual object is a virtual character competing in a virtual scene. In some embodiments, the number of virtual objects in the virtual scene battle is preset, or is dynamically determined according to the number of clients joining the battle, and the embodiments of the present disclosure are not limited to this. In one possible implementation, the user can control the virtual object to move in the virtual scene, for example, control the virtual object to run, jump, crawl, etc., and can also control the virtual object to fight with other virtual objects using skills, virtual props, etc. provided by the application. In some embodiments, when the virtual environment is a three-dimensional virtual environment, the virtual object can be a three-dimensional virtual model, each virtual object has its own shape and volume in the three-dimensional virtual environment, and occupies a part of the space in the three-dimensional virtual environment. In some embodiments, the virtual object is a three-dimensional character built based on three-dimensional human skeleton technology, and the virtual object achieves different external images by wearing different skins. In some implementations, the virtual object can also be implemented using a 2.5-dimensional or 2-dimensional model, which is not limited in the embodiments of the present disclosure.

### (5) Virtual Battle Task

The virtual battle task includes a virtual scene, and a virtual object and other virtual objects controlled by the player in the virtual scene. The virtual object is a virtual object controlled by the player using a first terminal device, and the other virtual objects are virtual objects controlled by other players who perform this virtual battle task together in this virtual battle task. Here, the virtual object and the other virtual objects belong to the same virtual camp.

The game control method provided in the embodiment of the present disclosure can be run on a local terminal device or a server. When the game control method is run on a server, the game control method can be implemented and executed based on a cloud interactive system, where the cloud interactive system includes a server and a client device.

In an embodiment, various cloud applications can be run under the cloud interactive system, such as a cloud game. Taking the cloud game as an example, the cloud game refers to a game method based on cloud computing. In the operation mode of the cloud game, the running subject of the game program and the presenting subject of the game screen are separated, the storage and operation of the game control method are completed on the cloud game server, and the client device is used for receiving and sending data and presenting the game screen. For example, the client device can be a display device with data transmission function close to the user side, such as a mobile terminal, a TV, a computer, a handheld computer, etc.; but the game control is performed by the cloud game server in the cloud. When playing the game, the player operates the client device to send an operation instruction to the cloud game server. The cloud game server runs the game according to the operation instruction, encodes and compresses the game screen and other data, and returns them to the client device through the network. Finally, the client device decodes and outputs the game screen.

In an implementation, taking a game as an example, a local terminal device stores a game program and is configured to present a game screen. The local terminal device is configured to interact with the player through a graphical user interface. That is, the game program is downloaded and installed and run conventionally through an electronic device. The local terminal device may provide the graphical user interface to the player in a variety of ways. For example, it may be rendered and displayed on the display screen of the terminal, or provided to the player through a holographic projection. For example, the local terminal device may include a display screen and a processor. The display screen is configured to present a graphical user interface. The graphical user interface includes a game screen, and the processor is configured to run the game, generate a graphical user interface, and control the display of the graphical user interface on the display screen.

Secondly, the application scenarios applicable to the present disclosure are introduced. The present disclosure can be applied to the field of game technology, such as shooting games, etc. In related games, players can compete with each other in limited maps and resources corresponding to virtual scenes, collect supplies, such as various weapons in the game, and scopes for upgrading firearms, some equipment and medicines, such as helmets, backpacks, flash bombs, and airdrop supplies. There are two ways to obtain airdrop supplies: first, summon a virtual vehicle (such as a helicopter) through a summoning prop (such as a flare) equipped by a virtual object, and the virtual vehicle drops airdrop supplies to the location of the virtual object by airdrop; second, during the game, the virtual vehicle drops airdrop supplies into the virtual environment at a fixed route and fixed time interval.

For example, the relevant game can be carried out in the following steps: in response to the condition that the number of players who have completed the game preparation phase reaches a first preset number, the virtual object that has completed the game preparation phase is controlled to enter the first game phase; during the first game phase, in response to the interactive behavior of the virtual object in the first game phase in the virtual scene, the virtual object is controlled to move in the virtual scene and pick up supplies. Specifically, the condition that the number of players who have completed the game preparation phase reaches the first preset number is configured to control the start of the current game, which can be understood as the game player sending a start request for the current game to the server through the terminal device. After receiving the start request for the current game, the server determines whether the received start request of the game player meets the starting condition of the current game. If it does, the game is controlled to start. Specifically, the starting condition of the current game (the starting condition of the game search phase) may include the following: the number of players participating in this game meets the requirements of the first preset number, for example, the number of players participating in this game meets 100, 120, or 140, etc., and the game starts; the online game time of the virtual objects participating in this game is not greater than the preset limit time specified by the game. For example, in order to prevent the game players from playing for too long and affecting their eyesight, the server sets a preset limit time. If the online game time exceeds the preset limit time, the server will force the game player to exit this game. Interactive behavior refers to the behavior of the virtual object controlled by the player to move in the virtual scene. For example, the behavior of the virtual object moving in the virtual scene may include but is not limited to at least one of the following: walking, running, jumping, climbing, lying down, attacking, releasing skills, picking up supplies, and sending messages. Here, the virtual objects active in the virtual scene include not only the virtual objects controlled by the player, but also virtual objects controlled by other players or other virtual objects not controlled by the player.

Specifically, when a virtual vehicle (such as a helicopter) drops airdrop supplies into a virtual scene at a fixed route and fixed time interval, the airdrop supplies will generate a special identifier in the virtual scene after landing, and a location identifier corresponding to the location of the airdrop supplies in the virtual scene will be generated on the scene thumbnail map. Players can find and loot the airdrop supplies based on the location identifier and the special identifier in the virtual scene.

However, it has been found that since the scene thumbnail map displays not only the location identifier corresponding to the airdrop supplies, but also the object identifiers corresponding to multiple virtual objects, a smaller scene thumbnail map displays more identifiers, which easily leads to the player's view of the relative position between the object identifier corresponding to the virtual object he controls and the location identifier corresponding to the airdrop supplies being blocked, and the display range of the special identifier corresponding to the airdrop supplies in the virtual scene is limited to a certain extent. In this way, the player controls the virtual object to move to the location of the airdrop supplies in the virtual scene while viewing the location identifier corresponding to the airdrop supplies displayed in the scene thumbnail map. This is not only inconvenient to operate, but also makes it easy for the player to be unable to accurately control the virtual object to move to the location of the airdrop supplies in the virtual scene due to the obstruction of vision, which ultimately leads to the player's search efficiency for airdrop supplies being reduced, thereby reducing the efficiency of human-computer interaction.

Based on this, the embodiment of the present disclosure provides a game control method, a game control device, an electronic device and a storage medium, and the player can quickly find the virtual supplies in the virtual scene according to the displayed orientation guide identifier, thereby improving the speed of the player's search for virtual supplies in the virtual scene, thereby improving the efficiency of human-computer interaction.

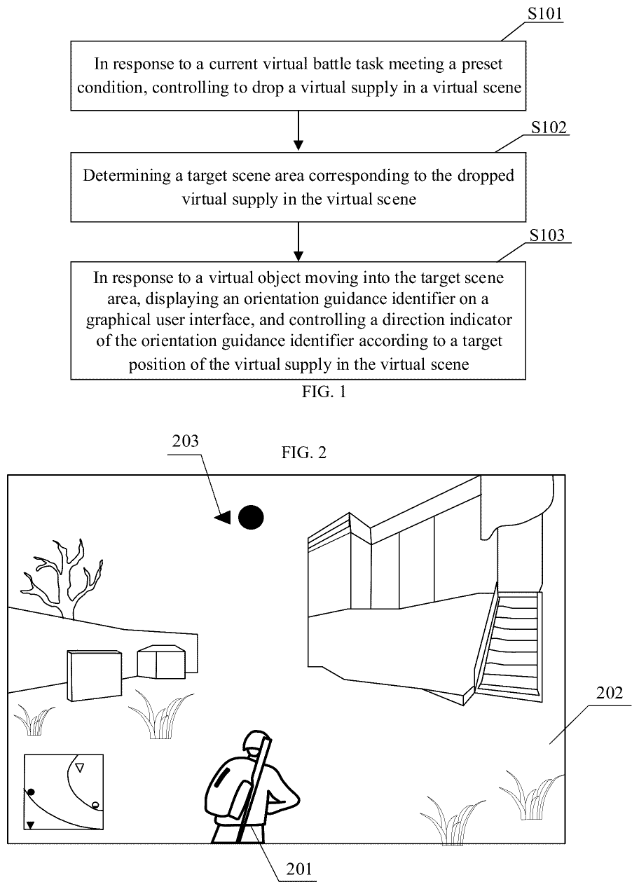

Please refer to FIG. 1, which is a flow chart of a game control method provided by the embodiment of the present disclosure. As shown in FIG. 1, the game control method provided by the embodiment of the present disclosure includes:
S101, in response to a current virtual battle task meeting a preset condition, controlling to drop a virtual supply in a virtual scene;
S102, determining a target scene area corresponding to the virtual supply dropped in the virtual scene;
S103, in response to a virtual object moving into the target scene area, displaying an orientation guidance identifier on a graphical user interface, and controlling a direction indicator of the orientation guidance identifier according to a target position of the virtual supply in the virtual scene.

The game control method provided by the embodiment of the present disclosure, after dropping virtual supplies in the virtual scene, the target scene area corresponding to the dropped virtual supplies in the virtual scene is determined, and after the virtual object moves to the target scene area, the orientation guidance identifier is displayed on the graphical user interface to guide the virtual object to move from the current position of the virtual object toward the virtual supplies in the virtual scene. In this way, after controlling the virtual object to move to the target scene area, the player can directly control the virtual object to move from the current position of the virtual object toward the virtual supplies in the virtual scene according to the orientation guidance identifier. The player does not need to check the location identifier corresponding to the airdrop supplies displayed in the scene thumbnail map while controlling the virtual object to move to the position of the airdrop supplies in the virtual scene. The operation is convenient, and the player's vision will not be affected by too many identifiers displayed on the graphical user interface, which helps to improve the player's efficiency in searching for airdrop supplies, so that the player can find the virtual supplies as soon as possible according to the orientation guidance identifier after entering the target scene area, which improves the speed of the player's search for virtual supplies in the virtual scene, thereby improving the efficiency of human-computer interaction.

To facilitate understanding of this embodiment, the following takes a game control method provided by the embodiment of the present disclosure applied to a terminal device as an example, and describes the above example steps provided by the embodiment of the present disclosure respectively.

In step S101, in response to the virtual battle task meeting the preset condition, controlling to drop the virtual supplies in the virtual scene.

In this step, the preset condition includes one of the following items:
(1) The game process of this virtual battle task reaches a preset time point.
(2) The virtual object in this virtual battle task executes a virtual vehicle summoning event, where the virtual vehicle is configured to drop virtual supplies in the virtual scene.
(3) The number of surviving virtual objects in this virtual battle task reaches a set number.

The following specifically describes the preset condition including the above three situations:
(1) The game process of this virtual battle task reaches a preset time point.

In one embodiment, the preset time point may be a fixed time point preset by the game system, and the fixed time point may be a time point uniformly set in the game mechanism. For example, when the game process of this virtual battle task reaches 20 minutes, the virtual supplies are controlled to be dropped in the virtual scene.

In this way, since the player knows in advance the fixed time point for dropping virtual supplies in the virtual scene, the player can prepare to search for virtual supplies in advance, avoiding the situation where the player misses the opportunity to search for virtual supplies due to not knowing the time to drop virtual supplies in the virtual scene, which helps to speed up the game process and indirectly improve the efficiency of human-computer interaction.

In another embodiment, the preset time point can be a random time point preset by the game system, and the random time point can be a time point randomly set in the game mechanism. For example, when the game process of this virtual battle task reaches 10 minutes, 20 minutes, or 30 minutes, the virtual supplies are controlled to be dropped in the virtual scene.

Here, since the time point for dropping virtual supplies in the virtual scene is a random time point, and the program code for the random time point in the computer is relatively not very complicated, a balance can be established between computer resources and the player's game experience. While improving the player's game experience, a large amount of computer resources does not need to be consumed to achieve the effect of game balance.
(2) The virtual object in this virtual battle task executes a virtual vehicle summoning event, where the virtual vehicle is configured to drop virtual supplies in the virtual scene.

The virtual vehicle summoning event refers to the summoning of a virtual vehicle (such as a helicopter) by a summoning prop (such as a flare) equipped by a virtual object, and the virtual vehicle drops virtual supplies into the virtual scene by airdrop.

Here, the time of dropping virtual supplies in the virtual scene can be controlled by the player himself. That is, the time when virtual supplies appear in the virtual scene can be controlled by the player himself. By executing the virtual vehicle summoning event, the virtual object can control the dropping of virtual supplies in the virtual scene. In this way, the virtual object that has found the summoning prop can summon and search for virtual supplies first, thereby encouraging players not only to wait for airdrop supplies, but also to search for summoning props in the virtual scene, increasing the diversification of virtual supplies delivery. Since the virtual supplies dropped in the virtual scene are more attractive, more players can be encouraged to compete for virtual supplies. Different camps will inevitably fight to eliminate some players, which can greatly reduce the number of players, thereby shortening the duration of a single game and indirectly improving the efficiency of human-computer interaction.
(3) The number of virtual objects that survive in this virtual battle task reaches the set number.

In this step, the set number is used as the starting condition for the game system to determine whether to drop virtual supplies in the virtual scene. During the virtual battle task, if the number of surviving virtual objects reaches the set number, the virtual supplies are triggered to be dropped in the virtual scene.

The set number can be determined by the game developer according to the numerical value set by the game design, or it can be determined by intelligent analysis of historical data in the virtual battle task through artificial intelligence technology.

In this way, triggering the drop of virtual supplies in the virtual scene according to the number of surviving virtual objects reaching the set number helps to gather scattered players to increase the possibility of confrontation between different players, thereby speeding up the elimination speed of each virtual object in the game, indirectly shortening the duration of a single game, and improving the efficiency of human-computer interaction.

In step S102, determining the target scene area corresponding to the virtual supplies dropped in the virtual scene. Here, the target scene area has at least the following two functions:

First, the target scene area can be configured to drop virtual supplies. Specifically, the target scene area has a certain boundary or range in the virtual scene, and the virtual object can move a distance in the target scene area or move for a period of time at the current moving speed in the target scene area. In one embodiment, when the system is dropping virtual supplies, a drop area is pre-determined as the target scene area, and virtual supplies are randomly dropped in this drop area; in one embodiment, the system pre-determines the precise location when dropping virtual supplies, and then determines the drop area corresponding to the precise location according to the system preset rules; where the system will drop the virtual supplies to the precise location, and the scene thumbnail map in the game will generate a supply area identifier corresponding to the drop area; in another embodiment, the system simultaneously determines the target scene area for dropping virtual supplies and the precise location when dropping virtual supplies in the target scene area, where the target scene area and the precise location appear at the same time and complement each other.

In the embodiment of the present disclosure, the target scene area is configured to drop virtual supplies, and the player can control the virtual object to search for virtual supplies in the target scene area after moving to the target scene area. Since the search area for virtual supplies is determined to be the target scene area, it is helpful for the player to know the search area for virtual supplies in advance, so as to accurately and timely adjust the moving direction of the virtual object to ensure that the virtual object always searches for virtual supplies in the target scene area, effectively improving the player's search efficiency for virtual supplies, and helping to speed up the game process.

Second, the target scene area can be used as a trigger area for triggering the display of an orientation guidance identifier on the graphical user interface. At this time, the target scene area can be unrelated to the precise location in the virtual scene for dropping virtual supplies. That is, when placing virtual supplies in the virtual scene, a target scene area can be simultaneously determined, and the target scene area is not used for dropping virtual supplies. However, after dropping virtual supplies in the virtual scene, if the player moves to the target scene area, the orientation guidance identifier for guiding the virtual object to move to the virtual supplies will be triggered on the graphical user interface.

For example, in related games, the above-mentioned target scene area can be used as one of the phases in the reward mechanism in the game. The design idea of the reward mechanism is as follows: when the player completes the specified task, the player can be provided with clues to move to the target scene area or the player can move to the target scene area by luck. When the player moves to the target scene area, the orientation guidance identifier can be triggered to be displayed on the graphical user interface, so that the player can quickly search for virtual supplies in the virtual scene according to the orientation guidance identifier. By setting up such a reward mechanism, players can be encouraged to actively complete specified tasks or actively move in the virtual scene, which helps to speed up the game process.

In the embodiment of the present disclosure, by setting a reward mechanism based on “the target scene area can trigger the display of the orientation guidance identifier”, multiple virtual objects are encouraged to search for the target scene area in the virtual scene and obtain corresponding virtual rewards (the virtual reward is the orientation guidance identifier displayed on the graphical user interface), so that the virtual object can complete the search for virtual supplies as soon as possible and enrich the game experience. At the same time, after moving to the target scene area, the player can quickly search for virtual supplies in the virtual scene according to the displayed orientation guidance identifier, which is convenient for the player to find the virtual supplies as soon as possible, helps to speed up the game process, and indirectly improves the efficiency of human-computer interaction.

In step S103, in response to the virtual object moving into the target scene area, the orientation guidance identifier is displayed on the graphical user interface, and the direction indicator of the orientation guidance identifier is controlled according to the target position of the virtual supplies in the virtual scene.

In the above steps, the orientation guidance identifier has a guidance direction, which is a direction from the current position of the virtual object to the target position of the virtual supplies in the virtual scene. Then, the player can control the virtual object to move from the current position of the virtual object to the target position of the virtual supplies in the virtual scene according to the orientation guidance identifier.

Specifically, the orientation guidance identifier may include one of a two-dimensional orientation guidance identifier and a three-dimensional orientation guidance identifier, and the orientation guidance identifier may be displayed in the form of a plane arrow, a three-dimensional arrow, etc., where the direction indicated by the plane arrow or the three-dimensional arrow points to the target position of the virtual supplies in the virtual scene. In one embodiment, the orientation guidance identifier may be set at the boundary of the graphical user interface to avoid blocking part of the virtual scene displayed in the graphical user interface; in another embodiment, the orientation guidance identifier may be set above the head of the virtual object, so that the player controlling the virtual object can observe the change of the orientation guidance identifier in time and adjust its route in time according to the change of the orientation guidance identifier.

For example, please refer to FIG. 2, which is a schematic diagram of a graphical user interface provided by an embodiment of the present disclosure. As shown in FIG. 2, after a virtual object 201 enters a target scene area 202 of a virtual scene, an orientation guidance identifier 203 will be displayed on the graphical user interface. The direction indicated by the orientation guidance identifier 203 points to the target position of the virtual supplies in the virtual scene. As shown in FIG. 2, the direction indicated by the orientation guidance identifier 203 is to the left of the current position of the virtual object 201. Then, the player can control the virtual object 201 to move to the target position where the virtual supplies are located according to the direction indicated by the orientation guidance identifier 203.

In addition, after the virtual object moves to the target scene area, text prompt information can also be displayed on the graphical user interface, and the text prompt information is configured to prompt the distance between the virtual object and the target position of the virtual supplies in the virtual scene, such as text prompt information popping up in the form of a pop-up window; voice prompt information can also be output, for example, when the virtual object is continuously moving close to the target position of the virtual supplies in the virtual scene, a “beep” sound will be emitted, or a voice “the distance between you and the virtual supplies has reached XX” will be broadcast, so that the player can find the virtual supplies as soon as possible under the prompt information, thereby saving the player's time to search for virtual supplies in the virtual scene.

In the embodiment of the present disclosure, displaying an orientation guidance identifier on the graphical user interface can provide accurate direction guidance for the virtual object to search for virtual supplies in the virtual scene, so that the virtual object can accurately and quickly move to the target position of the virtual supplies in the virtual scene according to the indicated direction provided by the orientation guidance identifier, which helps the virtual object to quickly find the virtual supplies in the virtual scene and saves the time of the virtual object to search for virtual supplies in the virtual scene. Moreover, the player does not need to check the position identifier corresponding to the virtual supplies displayed in the scene thumbnail map while controlling the virtual object to move to the target position of the virtual supplies in the virtual scene. The operation is convenient, and the player's sight will not be affected by too many identifiers displayed on the graphical user interface, which helps to improve the efficiency of the player's search for virtual supplies, so that the player can find the virtual supplies as soon as possible according to the orientation guidance identifier after entering the target scene area, thereby improving the speed of the player's search for virtual supplies in the virtual scene, thereby improving the efficiency of human-computer interaction.

In one embodiment, the embodiment of the present disclosure will be specifically described as follows based on the target scene area for the drop of virtual supplies:

When the target position of the virtual supplies in the virtual scene is located in the target scene area, in step S103, the step of displaying the orientation guidance identifier on the graphical user interface in response to the virtual object moving into the target scene area includes: in response to the virtual object moving into the target scene area, detecting a distance between the virtual object and the virtual supplies in the target scene area; and in response to the distance between the virtual object and the virtual supplies in the target scene area being less than a preset distance threshold, displaying the orientation guidance identifier on the graphical user interface.

In this step, since the virtual supplies are in the target scene area, when the virtual object moves to the target scene area, in response to the distance between the virtual object and the virtual supplies being less than the preset distance threshold, the orientation guidance identifier can be displayed on the graphical user interface, and the player can control the virtual object to move toward the target position according to the orientation guidance identifier.

The target scene area can be set to a regular shape, such as a circle, a square, etc. If the target scene area is a circle, the preset distance threshold is less than the diameter of the circular area corresponding to the target scene area; if the target scene area is a square, the preset distance threshold is less than the side length of the square area corresponding to the target scene area; the target scene area can also be set to an irregular shape, where the preset distance threshold can be set according to the experience of the game designer.

In this way, after the virtual object moves to the target scene area, if the orientation guidance identifier is displayed on the graphical user interface, it can be represented that the virtual object is approaching the target position where the virtual supplies are located, thereby reminding the player to adjust the moving direction of the virtual object controlled by the player in the target scene area in time, so that the virtual object moves to the target position where the virtual supplies are located as soon as possible, thereby saving the player's time in searching for virtual supplies and improving the efficiency of human-computer interaction.

In the related scheme, since the player can predict the position of the airdrop supplies in the virtual scene in advance, the virtual object can be controlled to move to the position where the airdrop supplies may land in advance, and then obtain the airdrop supplies. In this way, some old players may squat at the position where the airdrop supplies may land, so that some players, such as new players, dare not go to the position where the airdrop supplies may land to pick up the airdrop, which will prolong the game time of a single game and reduce the efficiency of human-computer interaction.

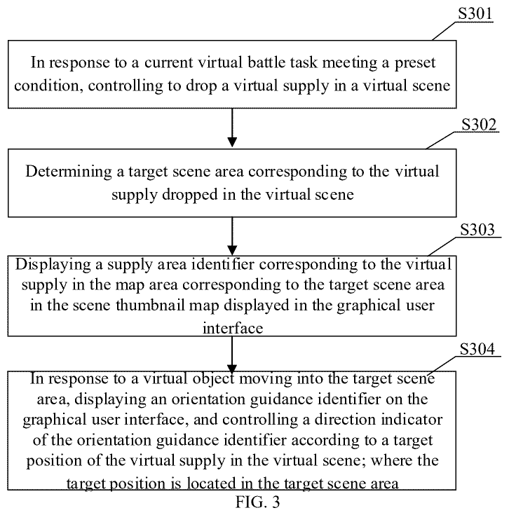

To solve the above-mentioned technical problems, the embodiment of the present disclosure provides another game control method. Please refer to FIG. 3, which is a flow chart of another game control method provided by the embodiment of the present disclosure. As shown in FIG. 3, the game control method provided by the embodiment of the present disclosure includes:
S301, in response to a current virtual battle task meeting a preset condition, controlling to drop a virtual supply in a virtual scene;
S302, determining a target scene area corresponding to the dropped virtual supply in the virtual scene;
S303, displaying a supply area identifier corresponding to the virtual supply in the map area corresponding to the target scene area in the scene thumbnail map displayed in the graphical user interface;
S304, in response to a virtual object moving into the target scene area, displaying an orientation guidance identifier on the graphical user interface, and controlling a direction indicator of the orientation guidance identifier according to a target position of the virtual supply in the virtual scene; where the target position is located in the target scene area.

The explanations of step S301, step S302 and step S304 can refer to the explanations of step S101 to step S103 above, and the repeated parts are not repeated.

In step S303, the supply area identifier corresponding to the virtual supplies is displayed in the map area corresponding to the target scene area in the scene thumbnail map displayed in the graphical user interface. Here, the target position is located in the target scene area.

In one embodiment, a map control is displayed on the graphical user interface, and in response to the touch operation on the map control, a scene thumbnail map is displayed on the graphical user interface. The scene thumbnail map is a thumbnail of the entire virtual scene, which includes a map area. The map area corresponds to the target scene area in the virtual scene. Since the target position of the virtual supplies in the virtual scene is located in the target scene area, the supply area identifier corresponding to the virtual supplies is displayed on the map area, and the player can control the virtual object to move toward the target position according to the supply area identifier. Here, the virtual scene, the target scene area, and the target position of the virtual supplies in the virtual scene are displayed in the scene thumbnail map corresponding to the map control according to a preset scale.

In an embodiment, step S303 specifically includes overlaying and displaying a supply area identifier with a preset area corresponding to the virtual supplies in the map area corresponding to the target scene area in the scene thumbnail map displayed in the graphical user interface.

In the above embodiment, the supply area identifier has a preset area. That is, the ratio of the occupied area of the supply area identifier in the scene thumbnail map to the total area of the scene thumbnail map is equal to the preset ratio threshold. Here, since the target scene area in the virtual scene has a certain range, and the scale of displaying the target scene area is the same as the scale of displaying the scene thumbnail map, and the area size of the target scene area is positively correlated with the movement distance obtained by the virtual object continuously moving for a preset time, the supply area identifier has a certain occupied area in the scene thumbnail map, and then it can be obtained that: the ratio of the occupied area of the supply area identifier in the scene thumbnail map to the total area of the scene thumbnail map is equal to the preset ratio threshold, where the preset ratio threshold can be determined according to the ratio of the actual area of the target scene area to the area of the entire virtual scene.

“Overlaying and displaying the supply area identifier with the preset area corresponding to the virtual supplies” can mean that the supply area identifier is overlaid on the map area. Here, the supply area identifier can be overlaid on the map area in a semi-transparent form to prevent the supply area identifier overlaid on the map area from blocking the map area, thereby affecting the player's line of sight when viewing the scene thumbnail map.

In the above method, since the supply area identifier is configured to represent the orientation information of the target scene area in the virtual scene, the supply area identifier in the embodiment of the present disclosure is no longer a coordinate point as shown in the related art, but the player can find the target scene area according to the supply area identifier displayed in the scene thumbnail map, providing a route reference for the virtual object controlled by the player to move to the target scene area, which helps the player to quickly reach the target scene area.

In this way, in the embodiment of the present disclosure, by displaying the supply area identifier corresponding to the virtual supplies in the map area corresponding to the target scene area in the scene thumbnail map, the player can control the virtual object to move toward the target scene area according to the supply area identifier displayed in the scene thumbnail map. Since the precise position of the virtual supplies does not need to be displayed, the specific calculation of the precise position of the virtual supplies can be avoided, thereby reducing the consumption of computer resources; since the player cannot predict the actual position of the virtual supplies in the virtual scene, the position of the virtual supplies in the virtual scene has a certain randomness, which can take into account the individual differences of the players to improve the fairness of the game; and the old players cannot squat in the position near the virtual supplies in advance, which can promote more new players to compete for the virtual supplies, thereby improving the development speed of the new players, and since more players gather in the target scene area where the virtual supplies are located, different camps are bound to fight to eliminate some players, thereby shortening the duration of a single game.

In one embodiment, in step S301, the step of controlling to drop virtual supplies in the virtual scene specifically includes generating virtual supplies at a preset height of the virtual scene; controlling the virtual supplies to move from the preset height to the target position of the virtual scene.

In the above steps, there is a period of time for dropping virtual supplies in the virtual scene. During this period of time, the player can control the virtual object to move to the target scene area according to the supply area identifier displayed in the scene thumbnail map, so as to provide more deployment time for the player to search for virtual supplies in the target scene area, thereby improving the player's gaming experience.

Further, step S303 specifically includes: in the process of controlling the virtual supplies to move from a preset height to the target position of the virtual scene, displaying the supply area identifier corresponding to the virtual supplies in the map area corresponding to the target scene area in the scene thumbnail map displayed in the graphical user interface.

Based on the above scheme, the embodiment of the present disclosure also includes: in response to the virtual supplies moving from a preset height to the target position of the virtual scene, controlling the supply area identifier to be updated to the supply location identifier displayed at the position corresponding to the target position of the scene thumbnail.

In the above scheme, in the process of controlling the virtual supplies to move from a preset height to the target position of the virtual scene, the supply area identifier corresponding to the virtual supplies is displayed in the map area of the scene thumbnail map, and when the virtual supplies move from the preset height to the target position of the virtual scene, the supply area identifier is controlled to be updated to the supply location identifier. The supply location identifier here is configured to represent the specific target position of the virtual supplies in the virtual scene.

In the embodiment of the present disclosure, during the process of dropping virtual supplies in a virtual scene, a supply area identifier corresponding to the virtual supplies is displayed in the map area of the scene thumbnail map. When the virtual supplies move from a preset height to a target position in the virtual scene, in addition to displaying the supply location identifier corresponding to the virtual supplies in the map area of the scene thumbnail map, an orientation guidance identifier is also displayed on the graphical user interface.

In this way, during the process of dropping virtual supplies, the player controls the virtual object to move to the target scene area according to the orientation of the supply area identifier on the scene thumbnail map, where the supply area identifier only represents the position range of the virtual supplies in the virtual scene. Since the player cannot predict the actual position of the virtual supplies in the virtual scene, the old players cannot squat in the position near the virtual supplies in advance, which can promote more new players to compete for virtual supplies, thereby improving the development speed of new players. Moreover, since more players search for virtual supplies in a similar time period, different camps are bound to fight to eliminate some players, thereby shortening the duration of a single game. When the virtual supplies move from a preset height to the target position of the virtual scene, the player can control the virtual object to move to the target position and search for virtual supplies according to the orientation guidance identifier and the supply location identifier at the same time, which helps to improve the player's search efficiency and search accuracy, thereby improving the efficiency of human-computer interaction.

In one embodiment, a target scene area for dropping virtual supplies is generated in the virtual scene, and then a supply area identifier corresponding to the virtual supplies is displayed in the map area corresponding to the target scene area in the scene thumbnail map displayed in the graphical user interface; in another embodiment, multiple target scene areas for dropping virtual supplies are generated in the virtual scene, and then multiple supply area identifiers corresponding to the virtual supplies are displayed in the map areas corresponding to the target scene areas in the scene thumbnail map displayed in the graphical user interface. Here, when multiple supply area identifiers are displayed on the scene thumbnail map, in order to distinguish the supply area identifiers corresponding to different target scene areas, the shapes and/or colors of respective supply area identifiers can be set to be different. Specifically, the supply area identifier in the embodiment of the present disclosure has a certain occupied area, and then different colors, different patterns, or different stripes can be filled into different supply area identifiers to distinguish different supply area identifiers.

In a specific embodiment, the embodiment of the present disclosure further includes: displaying supply area identifiers corresponding to the virtual supplies displayed in the map areas corresponding to different target scene areas in the scene thumbnail map differently; where the different target scene areas are configured to drop virtual supplies of different levels.

Specifically, the display form of the differentiated display includes at least one of the following items: display brightness, display shape, and filled color.

In the above manner, the display form of the differentiated display of the supply area identifiers in the map areas of the scene thumbnail map corresponding to the target scene areas where the virtual supplies of different levels are located may include multiple display forms, so as to realize the differentiated display of the different supply area identifiers, so that they have a distinguishability, and help players quickly distinguish the supply area identifiers of different levels displayed on the scene thumbnail map.

The following specifically describes the display forms including display brightness, display shape, and filled color, and the display forms including at least two of display brightness, display shape, and filled color:

First, when the display form is display brightness, the supply area identifiers in the map areas corresponding to the target scene areas where the virtual supplies of different levels are located are displayed differently by different display brightness.

Here, display brightness refers to the luminous intensity of a supply area identifier per unit projected area on a surface in a given direction, where the given direction is a direction perpendicular to the graphical user interface. Display brightness can vary from extremely dark (minimum brightness) to extremely bright (maximum brightness).

According to the above characteristics of display brightness, display brightness can be divided into multiple brightness levels, and the brightness levels of display brightness correspond to the levels of virtual supplies in the target scene area one by one. The level of virtual supplies is positively correlated with the brightness level of display brightness.

For example, assuming that the virtual supplies configured to be dropped to the target scene area include five levels, namely, low-equipped supply level, ordinary supply level, rare supply level, exceptionally rare supply level, and super supply level. Different brightness levels of display brightness are set for these five levels of virtual supplies, where the brightness of the supply area identifier associated with the super supply level is the largest, and the brightness of the supply area identifier associated with the low-equipped supply level is the smallest.

Displaying supply area identifiers with different display brightness helps players distinguish different levels of virtual supplies in different target scene areas, and facilitates players to make reasonable tactical deployments according to their current positions in the virtual scene, so as to reach the target scene area suitable for the player to search for virtual supplies.

Second, when the display form is a display shape, different display shapes are configured to distinguish the display of the supply area identifiers in the map areas corresponding to the target scene areas where virtual supplies of different levels are located.

Here, the display shape refers to the existence or expression form of the supply area identifier in the map area of the scene thumbnail map. For example, the display shape can include a circle, a heart shape, a square, a pentagon, an irregular shape, etc. Different display shapes can be configured to distinguish the display of the supply area identifiers included in the target scene areas to which virtual supplies of different levels belong.

For example, assuming that the virtual supplies configured to be dropped to the target scene area include five levels, namely, low-equipped supply level, ordinary supply level, rare supply level, exceptionally rare supply level, and super supply level. For example, a circular icon can be configured to represent the supply area identifier corresponding to the target scene area to which virtual supplies of the low-equipped supply level belong, and an irregular graphic icon can be configured to represent the supply area identifier corresponding to the target scene area to which virtual supplies of the super supply level belong, etc.

The supply area identifiers in the map areas corresponding to the target scene areas where virtual supplies of different levels are located are displayed by different display shapes. Since the difference between different display shapes is large, the different levels of virtual supplies in different target scene areas can be significantly distinguished, so that players can know the levels of virtual supplies in the target scene area in a timely manner.

Third, when the display form is filled color, the supply area identifiers in the map areas corresponding to the target scene areas where virtual supplies of different levels are located are displayed by different filled colors.

Here, the filled colors include red, yellow, green, blue, purple, etc. Since the supply area identifier has an area, in order to distinguish the supply area identifiers corresponding to virtual supplies of different levels, different colors can be filled for the supply area identifiers in the map areas corresponding to the target scene areas where virtual supplies of different levels are located.

For example, the supply area identifier related to the super supply level is filled with red, and the supply area identifier related to the low-equipped supply level is filled with yellow.

The supply area identifiers corresponding to the target scene areas where virtual supplies of different levels are located are displayed by different filled colors. Since the difference between different filled colors is large, the different levels of virtual supplies in different target scene areas can be significantly distinguished, so that players can know the levels of virtual supplies in different target scene areas in a timely manner.

In addition, any two combinations of display brightness, display shape and filled color included in the display form, or a combination of three can be displayed. For example, the supply area identifiers corresponding to the target scene areas where virtual supplies of different levels are located are displayed differently by display brightness and filled color; or the supply area identifiers in the map areas corresponding to the target scene areas where virtual supplies of different levels are located are displayed differently by display brightness, display shape and filled color.

It should be noted that the specific contents of respective display forms described in the above records are also applicable to the present embodiment after combining at least two display forms, which will not be repeated here.

In this way, through the random combination of multiple display forms, the purpose of distinguishing the display of different supply area identifiers is significantly achieved, so that players can easily distinguish the differences between different supply area identifiers, which helps players to know the levels of virtual supplies in the target scene areas corresponding to different supply area identifiers in a timely manner, facilitates players to make reasonable tactical deployments, and improves players' gaming experience. Moreover, a variety of different display forms can meet the gaming needs of different players, adapt to the gaming habits of different players, and improve players' visual experience.

In the relevant scheme, in order to enable the player to better observe the positional relationship between the virtual object and the target scene area, the embodiment of the present disclosure also includes:

displaying a virtual object identifier corresponding to the virtual object in the scene thumbnail map displayed in the graphical user interface; where, the position of the virtual object identifier in the scene thumbnail map is updated in real time according to the movement of the virtual object in the virtual scene.

In this step, the player can control the virtual object to move to the target scene area according to the relative position between the virtual object identifier and the supply area identifier displayed in the scene thumbnail map, and find the target scene area. Correspondingly, according to the orientation information of the virtual object in the virtual scene, the generation position of the virtual object identifier in the scene thumbnail map is determined, where the generation position of the virtual object identifier in the scene thumbnail map corresponds to the orientation information of the virtual object in the virtual scene.

Since the relevant game includes multiple camps, each camp includes multiple virtual objects, and the virtual objects in the same camp are teammates. Specifically, on the scene thumbnail map, the virtual object can see the position information of its teammates in the virtual scene. In this way, multiple virtual object identifiers can be displayed on the scene thumbnail map at the same time, where the virtual objects corresponding to the virtual object identifiers displayed in the scene thumbnail map belong to the same camp. When the virtual object is eliminated, the virtual object identifier corresponding to the virtual object will disappear from the scene thumbnail map.

For example, the virtual object identifier may include any one of the following items: letter identifier, text identifier, digital identifier, graphic identifier, special symbol identifier. In order to facilitate players to distinguish between virtual object identifiers and supply area identifiers, virtual object identifiers and supply area identifiers can be set to different types of identifiers, such as using different display shapes to distinguish different supply area identifiers, and using different colors to distinguish different virtual object identifiers, so as to ensure that the virtual object identifier and supply area identifier are displayed to players more intuitively.

In this way, while the supply area identifier is displayed in the scene thumbnail map, the virtual object identifier is also displayed on the graphical user interface, so that the player controls the virtual object to move to the target scene area according to the relative position between the virtual object identifier and the supply area identifier displayed in the scene thumbnail map, which can improve the movement speed and accuracy of the virtual object to the target scene area, help the player to quickly reach the target scene area, avoid the player missing the opportunity to enter the target scene area to search for virtual supplies, and indirectly improve the efficiency of human-computer interaction.

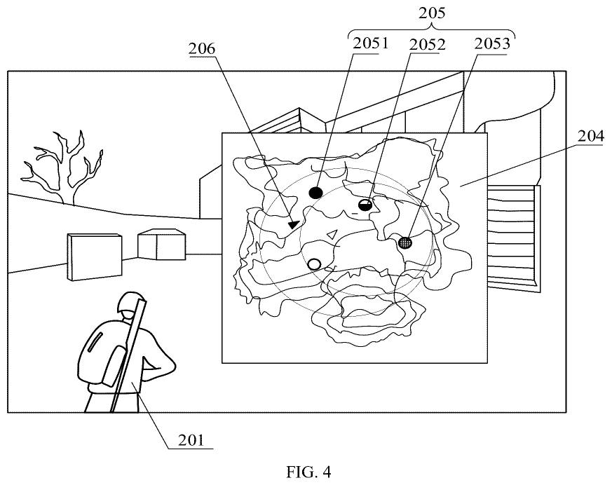

For example, please refer to FIG. 4, which is a schematic diagram of another graphical user interface provided by the embodiment of the present disclosure. As shown in FIG. 4, in the scene thumbnail map 204, supply area identifiers 205 and a virtual object identifier 206 are displayed, where the supply area identifiers in the scene thumbnail map corresponding to the target scene areas where virtual supplies of different levels are located are displayed differently. As shown in FIG. 4, the supply area identifier 205 includes a first supply area identifier 2051 (black circle), a second supply area identifier 2052 (a circle partially filled with black), and a third supply area identifier 2053 (a circle filled with a grid). For the first supply area identifier 2051 (black circle), the first supply area identifier 2051 with the circle filled with black represents that the first virtual supplies are moved to the target position of the virtual scene, and the second supply area identifier 2052 with the circle partially filled with black represents that the second virtual supplies are in the process of moving from a preset height to the target position of the virtual scene, where the supply level of the first virtual supplies is the same as that of the second virtual supplies; the third supply area identifier 2053 with the circle filled with a grid represents that the third virtual supplies are moved to the target position of the virtual scene, and the supply level of the third virtual supplies is different from that of the first virtual supplies. The virtual object 201 is located in the virtual scene, and the player can control the virtual object 201 to move to the target scene area according to the relative position relationship between the supply area identifier 205 and the virtual object identifier 206.

In order to enable the player to reasonably arrange the time for the virtual object controlled by the player to move to the target scene area to search for virtual supplies, the embodiment of the present disclosure adopts the following scheme:

displaying a timing control on the graphical user interface; where the timing control is configured to display a countdown according to the moment when the virtual supplies are started to be dropped in the virtual scene and the moment when the virtual supplies appear in the target scene area; adjusting the display forms of the supply area identifiers corresponding to the virtual supplies displayed in the map areas corresponding to the target scene areas in the scene thumbnail map according to the countdown displayed in the timing control.

Here, the timing control is configured to display a countdown according to the moment when the virtual supplies are started to be dropped in the virtual scene and the moment when the virtual supplies appear in the target scene area. That is, the countdown starts from the moment when the virtual supplies are started to be dropped in the virtual scene, and the countdown ends when the virtual supplies appear in the target scene area, and the virtual supplies are controlled to appear in the target scene area.

In this way, the timing control can display a countdown based on the time when the virtual supplies are started to be dropped in the virtual scene and the time when the virtual supplies appear in the target scene area, so that the player can accurately grasp the initial time when the virtual supplies appear in the target scene area, and then reasonably arrange the time for the player to move to the target scene area, so as to achieve the purpose of searching for virtual supplies in the target scene area in time, optimize the information prompt method in the game, and promote human-computer interaction.

Specifically, as the countdown time displayed in the timing control changes, the display form of the supply area identifier in the scene thumbnail map also changes with the countdown time progress.

Here, when the display form is display brightness, as the countdown time displayed in the timing control changes, the display brightness of the supply area identifier in the scene thumbnail map becomes larger and larger; when the display form is display shape, as the countdown time displayed in the timing control changes, the display shape of the supply area identifier in the scene thumbnail map becomes larger and larger (from nothing to something), where the ratio of the occupied area of the display shape of the supply area identifier corresponding to the end of the countdown to the total area of the scene thumbnail map is equal to the preset ratio threshold; when the display form is filled color, as the countdown time displayed in the timing control changes, the filled area of the supply area identifier in the scene thumbnail map becomes larger and larger, where the filled area of the supply area identifier corresponding to the end of the countdown is equal to the occupied area of the supply area identifier in the scene thumbnail map. When filling the supply area identifier, color, pattern, stripe, etc. can be used as filler.

For example, the embodiment of the present disclosure uses a target color to fill the supply area identifier corresponding to the virtual supplies displayed in the map area corresponding to the target scene area in the scene thumbnail map according to the time progress of the countdown displayed in the timing control; where the time progress of the countdown is correlated with the filling area of the supply area identifier, and the target color is determined according to the level of the virtual supplies dropped in the target scene area.

Here, since the filling colors corresponding to virtual supplies of different levels are pre-set, the target color can be determined according to the level of the virtual supply dropped in the target scene area. In addition, the time progress of the countdown is positively correlated with the filling area of the supply area identifier, which can highlight the importance of the target color for distinguishing different supply area identifiers.

In this way, the dynamic change of the filling color on the supply area identifier can enable the player to accurately grasp the initial time of searching for virtual supplies in the target scene area, which can avoid the time wasted by the player searching when there is no virtual supply in the target scene area, and help improve the player's search efficiency.

In another embodiment, the embodiment of the present disclosure will use the target scene area as a trigger area for triggering the display of the orientation guidance identifier on the graphical user interface as an example to specifically explain the case as follows:

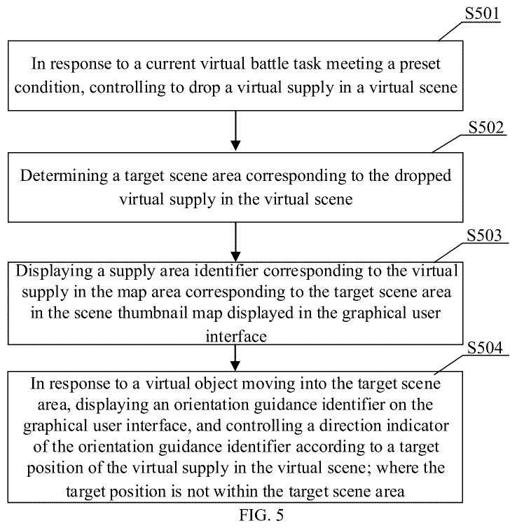

Please refer to FIG. 5, which is a flowchart of another game control method provided by the embodiment of the present disclosure. As shown in FIG. 5, the game control method provided by the embodiment of the present disclosure includes:
S501, in response to a current virtual battle task meeting a preset condition, controlling to drop a virtual supply in a virtual scene;
S502, determining a target scene area corresponding to the dropped virtual supply in the virtual scene;
S503, displaying a supply area identifier corresponding to the virtual supply in the map area corresponding to the target scene area in the scene thumbnail map displayed in the graphical user interface;
S504, in response to a virtual object moving into the target scene area, displaying an orientation guidance identifier on the graphical user interface, and controlling a direction indicator of the orientation guidance identifier according to a target position of the virtual supply in the virtual scene; where the target position is not within the target scene area.

The explanation of steps S501 to S503 can refer to the explanation of steps S301 to S303 above, and the repeated parts will not be repeated.

For step S504, there is no virtual supply in the target scene area. At this time, the target scene area is used as a trigger area for triggering the display of the orientation guidance identifier on the graphical user interface.

In the embodiment of the present disclosure, the player can search for the target scene area in the virtual scene according to the supply area identifier displayed on the graphical user interface. After the virtual object moves to the target scene area, the orientation guidance identifier for guiding the virtual object to move toward the virtual supply is displayed on the graphical user interface. That is to say, when the player finds the target scene area, the direction information (orientation guidance identifier) guiding the player to find the virtual supply can be obtained, so that the player can control the virtual object to quickly find the virtual supply in the virtual scene according to the orientation guidance identifier. This setting can promote the player to actively complete the specified task or actively move in the virtual scene to find the target scene area, and provide the orientation guidance identifier guiding the virtual object to move to the virtual supply after the player finds the target scene area, thereby improving the player's search efficiency for virtual supplies, thereby speeding up the game process and improving the efficiency of human-computer interaction.

In an embodiment, the embodiment of the present disclosure further includes: in response to the virtual supplies in the target scene area being picked up, controlling the deletion of the supply area identifier corresponding to the virtual supplies from the map area corresponding to the target scene area in the scene thumbnail map.

In this way, the player can timely change the player's own route according to the supply area identifier that disappears in the scene thumbnail map, avoiding the problem that the virtual object not only cannot pick up supplies when it reaches the target scene area, but is also easily ambushed by other players.

In the game control method provided by the embodiment of the present disclosure, the player can control the virtual object to move toward the target scene area according to the relative position between the supply area identifier and the virtual object identifier displayed in the scene thumbnail map; after the virtual object moves to the target scene area, the orientation guide identifier is displayed on the graphical user interface to guide the virtual object to move from the current position of the virtual object toward the virtual supplies. In the above manner, since there is no need to display the exact location of virtual supplies, the specific calculation of the exact location of virtual supplies can be avoided, thereby reducing the consumption of computer resources; since players cannot predict the actual location of virtual supplies in the virtual scene, the location of virtual supplies in the virtual scene has a certain degree of randomness, which can take into account the individual differences of players to improve the fairness of the game; and old players cannot squat near the location of virtual supplies in advance, which can promote more new players to compete for virtual supplies, thereby improving the development speed of new players, and since more players search for virtual supplies in a similar time period, different camps will inevitably fight to eliminate some players, thereby shortening the duration of a single game; after moving to the target scene area, the player can find the virtual supply as soon as possible according to the orientation guidance identifier, which improves the speed of the player's search for virtual supplies in the virtual scene, helps to shorten the duration of a single game, and improves the efficiency of human-computer interaction.

Based on the same inventive concept, the embodiment of the present disclosure also provides a game control device corresponding to the game control method. Since the principle of solving the problem by the device in the embodiment of the present disclosure is similar to the above-mentioned game control method in the embodiment of the present disclosure, the implementation of the device can refer to the implementation of the method, and the repeated parts will not be repeated.

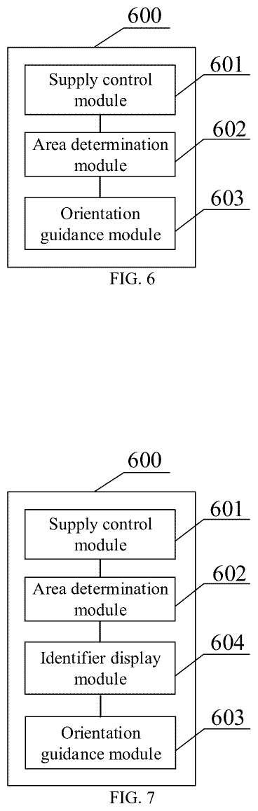

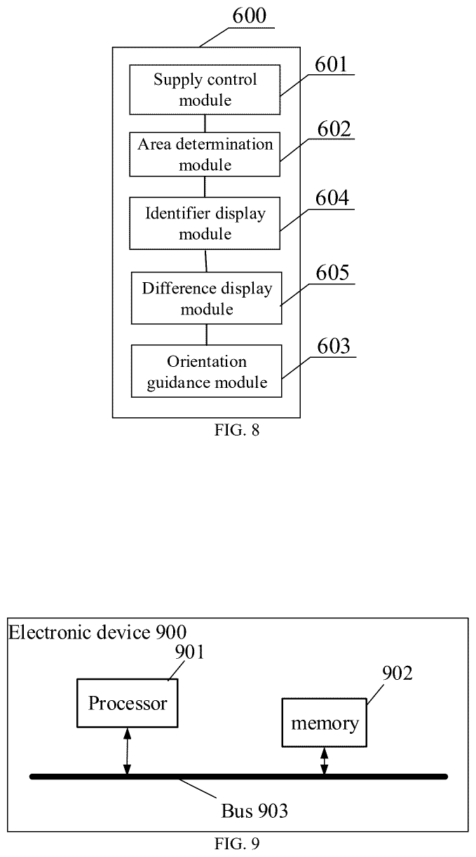

Please refer to FIG. 6, FIG. 7 and FIG. 8. FIG. 6 is a schematic diagram of a structure of a game control device provided in an embodiment of the present disclosure, FIG. 7 is a schematic diagram of a structure of another game control device provided in an embodiment of the present disclosure, and FIG. 8 is a schematic diagram of a structure of another game control device provided in an embodiment of the present disclosure. As shown in FIG. 6, a game control device 600 provided in an embodiment of the present disclosure includes:

a supply control module 601, configured to control to drop a virtual supply in a virtual scene in response to a virtual battle task meeting a preset condition;

an area determination module 602, configured to determine a target scene area corresponding to the dropped virtual supply in the virtual scene;

an orientation guidance module 603, configured to display an orientation guidance identifier on a graphical user interface in response to a virtual object moving into the target scene area, and control a direction indicator of the orientation guidance identifier according to a target position of the virtual supply in the virtual scene.

In an embodiment of the present disclosure, the target position is located in the target scene area.

In an embodiment of the present disclosure, the orientation guidance module 603 is specifically configured to:

in response to the virtual object moving into the target scene area, detect a distance between the virtual object and the virtual supply in the target scene area; and

in response to the distance between the virtual object and the virtual supply in the target scene area being less than a preset distance threshold, display the orientation guidance identifier on the graphical user interface.

Further, as shown in FIG. 7, the device 600 further includes an identifier display module 604, and the identifier display module 604 is configured to:

display a supply area identifier corresponding to the virtual supply in the map area corresponding to the target scene area in the scene thumbnail map displayed in the graphical user interface.

In an embodiment of the present disclosure, the identifier display module 604 is specifically configured to:

overlay and display a supply area identifier with a preset area corresponding to the virtual supply at the map area corresponding to the target scene area in the scene thumbnail map displayed in the graphical user interface.

In an embodiment of the present disclosure, the supply control module 601 is specifically configured to:

generate a virtual supply at a preset height of the virtual scene;

control the virtual supply to move from the preset height to a target position of the virtual scene.

In an embodiment of the present disclosure, the identifier display module 604 is specifically configured to:

in the process of controlling the virtual supply to move from the preset height to the target position of the virtual scene, display the supply area identifier corresponding to the virtual supply in the map area corresponding to the target scene area in the scene thumbnail map displayed in the graphical user interface.

In an embodiment of the present disclosure, the device also includes an identifier update module (not shown in the figure), which is configured to:

in response to the virtual supply moving from the preset height to the target position of the virtual scene, control the supply area identifier to be updated to the supply location identifier displayed at the position corresponding to the target position in the scene thumbnail.

Further, as shown in FIG. 8, the device 600 also includes a difference display module 605, which is configured to:

display the supply area identifiers corresponding to the virtual supplies displayed in the map areas corresponding to different target scene areas in the scene thumbnail map differently; where different target scene areas are used to drop virtual supplies of different levels.

In an embodiment of the present disclosure, the device further includes a timing display module (not shown in the figure), which is configured to:

display a timing control on a graphical user interface; where the timing control is configured to display a countdown according to the moment when the virtual supply is generated at a preset height of the virtual scene and the moment when the virtual supply moves from the preset height to the target position of the virtual scene; and

adjust the display form of the supply area identifier corresponding to the virtual supply displayed in the map area corresponding to the target scene area in the scene thumbnail map according to the countdown displayed in the timing control.

In an embodiment of the present disclosure, the timing display module is further configured to:

fill the supply area identifier corresponding to the virtual supply displayed in the map area corresponding to the target scene area in the scene thumbnail map with a target color according to the time progress of the countdown displayed in the timing control; where the time progress of the countdown is correlated with the filling area of the supply area identifier, and the target color is determined according to the level of the virtual supply dropped in the target scene area.

In an embodiment of the present disclosure, the device further includes an object display module (not shown in the figure), which is configured to:

display a virtual object identifier corresponding to the virtual object in the scene thumbnail map displayed in the graphical user interface;

where the position of the virtual object identifier in the scene thumbnail map is updated in real time according to the movement of the virtual object in the virtual scene.

In an embodiment of the present disclosure, the device further includes an identifier deletion module (not shown in the figure), which is configured to:

in response to the virtual supply in the target scene area being picked up, control the deletion of the supply area identifier corresponding to the virtual supply from the map area corresponding to the target scene area in the scene thumbnail map.

In an embodiment of the present disclosure, the preset condition includes one of the following items:

the game process of this virtual battle task reaches a preset time point;

the virtual object in this virtual battle task executes a virtual vehicle summoning event, where the virtual vehicle is configured to drop virtual supplies into the virtual scene; and

the number of surviving virtual objects in this virtual battle task reaches a set number.

In the game control device provided in the embodiment of the present disclosure, the player can control the movement of the virtual object toward the target scene area according to the relative position between the supply area identifier and the virtual object identifier displayed in the scene thumbnail map; after the virtual object moves to the target scene area, an orientation guidance identifier is displayed on the graphical user interface to guide the virtual object to move from the current position of the virtual object toward the virtual supply. In the above manner, since there is no need to display the exact location of virtual supplies, the specific calculation of the exact location of virtual supplies can be avoided, thereby reducing the consumption of computer resources; since players cannot predict the actual location of virtual supplies in the virtual scene, the location of virtual supplies in the virtual scene has a certain degree of randomness, which can take into account the individual differences of players to improve the fairness of the game; and old players cannot squat near the location of virtual supplies in advance, which can promote more new players to compete for virtual supplies, thereby improving the development speed of new players, and since more players search for virtual supplies in a similar time period, different camps are bound to fight to eliminate some players, thereby shortening the duration of a single game; after moving to the target scene area, the player can find the virtual supply as soon as possible according to the orientation guidance identifier, which improves the speed of the player's search for virtual supplies in the virtual scene, helps to shorten the duration of a single game, and improves the efficiency of human-computer interaction.

Please refer to FIG. 9, which is a structural schematic diagram of an electronic device provided in an embodiment of the present disclosure. As shown in FIG. 9, the electronic device 900 includes a processor 901, a memory 902 and a bus 903.

The memory 902 stores machine-readable instructions executable by the processor 901. When the electronic device 900 is running, the processor 901 communicates with the memory 902 through the bus 903, so that the processor 901 executes the following instructions when running:

in response to a virtual battle task meeting a preset condition, controlling to drop a virtual supply in a virtual scene;

determine a target scene area corresponding to the dropped virtual supply in the virtual scene; and

in response to a virtual object moving into the target scene area, displaying an orientation guidance identifier on the graphical user interface, and controlling a direction indicator of the orientation guidance identifier according to a target position of the virtual supply in the virtual scene.

In an embodiment of the present disclosure, the target position is located in the target scene area.

In an embodiment of the present disclosure, when the processor 901 displays the orientation guidance identifier on the graphical user interface in response to the virtual object moving into the target scene area, the following instructions are specifically executed:

in response to the virtual object moving into the target scene area, detecting a distance between the virtual object and the virtual supply in the target scene area; and

in response to the distance between the virtual object and the virtual supply in the target scene area being less than the preset distance threshold, display the orientation guidance identifier on the graphical user interface.

In an embodiment of the present disclosure, the processor 901 further executes the following instructions:

displaying a supply area identifier corresponding to the virtual supply in the map area corresponding to the target scene area in the scene thumbnail map displayed in the graphical user interface.

In an embodiment of the present disclosure, when the processor 901 displays the supply area identifier corresponding to the virtual supply in the map area corresponding to the target scene area in the scene thumbnail map displayed in the graphical user interface, the processor 901 specifically executes the following instructions:

overlaying and displaying a supply area identifier with a preset area corresponding to the virtual supply in the map area corresponding to the target scene area in the scene thumbnail map displayed in the graphical user interface.

In an embodiment of the present disclosure, when the processor 901 executes the step of controlling to drop the virtual supply in the virtual scene, the processor 901 specifically executes the following instructions:

generating the virtual supply at a preset height of the virtual scene; and

controlling the virtual supply to move from the preset height to the target position of the virtual scene.

In an embodiment of the present disclosure, when the processor 901 executes the step of displaying the supply area identifier corresponding to the virtual supply in the map area corresponding to the target scene area in the scene thumbnail map displayed in the graphical user interface, the processor 901 specifically executes the following instructions when:

in the process of controlling the virtual supply to move from the preset height to the target position of the virtual scene, displaying the supply area identifier corresponding to the virtual supply in the map area corresponding to the target scene area in the scene thumbnail map displayed in the graphical user interface.

In an embodiment of the present disclosure, the processor 901 also executes the following instructions:

in response to the virtual supply moving from the preset height to the target position of the virtual scene, controlling the supply area identifier to be updated to the supply location identifier displayed at the position corresponding to the target position of the scene thumbnail.

In an embodiment of the present disclosure, the processor 901 also executes the following instructions:

displaying the supply area identifiers corresponding to the virtual supplies displayed in the map areas corresponding to different target scene areas in the scene thumbnail map differently; where different target scene areas are used to drop virtual supplies of different levels.

In an embodiment of the present disclosure, the processor 901 further executes the following instructions:

displaying a timing control on the graphical user interface; where the timing control is configured to display a countdown according to the moment when the virtual supply is generated at the preset height of the virtual scene and the moment when the virtual supply moves from the preset height to the target position of the virtual scene; and

adjusting the display form of the supply area identifier corresponding to the virtual supply displayed in the map area corresponding to the target scene area in the scene thumbnail map according to the countdown displayed in the timing control.

In an embodiment of the present disclosure, when the processor 901 is running to adjust the display form of the supply area identifier corresponding to the virtual supply displayed in the map area corresponding to the target scene area in the scene thumbnail map according to the countdown displayed in the timing control, the following instructions are specifically executed:

filling the supply area identifier corresponding to the virtual supply displayed in the map area corresponding to the target scene area in the scene thumbnail map with the target color according to the time progress of the countdown displayed in the timing control; where the time progress of the countdown is correlated with the filling area of the supply area identifier, and the target color is determined according to the level of the virtual supply dropped in the target scene area.

In an embodiment of the present disclosure, the processor 901 further executes the following instructions:

displaying a virtual object identifier corresponding to the virtual object in the scene thumbnail map displayed in the graphical user interface;

where updating the position of the virtual object identifier in the scene thumbnail map in real time according to the movement of the virtual object in the virtual scene.

In an embodiment of the present disclosure, the processor 901 further executes the following instructions:

in response to the virtual supply in the target scene area being picked up, controlling the deletion of the supply area identifier corresponding to the virtual supply from the map area corresponding to the target scene area in the scene thumbnail map.

In an embodiment of the present disclosure, the preset condition includes one of the following items:

the game process of this virtual battle task reaches a preset time point;

the virtual object in this virtual battle task executes a virtual vehicle summoning event, where the virtual vehicle is configured to drop virtual supplies to the virtual scene; and

the number of surviving virtual objects in this virtual battle task reaches a set number.

According to the game control method provided by the embodiment of the present disclosure, the player can control the movement of the virtual object toward the target scene area according to the relative position between the supply area identifier and the virtual object identifier displayed in the scene thumbnail map; after the virtual object moves to the target scene area, an orientation guidance identifier is displayed on the graphical user interface to guide the virtual object to move from the current position of the virtual object toward the virtual supply. In the above manner, since there is no need to display the exact location of virtual supplies, the specific calculation of the exact location of virtual supplies can be avoided, thereby reducing the consumption of computer resources; since players cannot predict the actual location of virtual supplies in the virtual scene, the location of virtual supplies in the virtual scene has a certain degree of randomness, which can take into account the individual differences of players to improve the fairness of the game; and old players cannot squat near the location of virtual supplies in advance, which can promote more new players to compete for virtual supplies, thereby increasing the development speed of new players, and since more players search for virtual supplies in a similar time period, different camps are bound to fight to eliminate some players, thereby shortening the duration of a single game; after moving to the target scene area, players can find the virtual supplies as soon as possible according to the orientation guidance identifier, which improves the speed of players searching for virtual supplies in the virtual scene, helps to shorten the duration of a single game, and improves the efficiency of human-computer interaction.

The embodiment of the present disclosure also provides a computer-readable storage medium, on which a computer program is stored, and when the computer program is executed by a processor, the following instructions are executed:

in response to a virtual battle task meeting a preset condition, controlling to drop a virtual supply in a virtual scene;

determining a target scene area corresponding to the dropped virtual supply in the virtual scene;

in response to a virtual object moving into the target scene area, displaying an orientation guidance identifier on a graphical user interface, and controlling a direction indicator of the orientation guidance identifier according to a target position of the virtual supply in the virtual scene.

In an embodiment of the present disclosure, the target position is located in the target scene area.

In an embodiment of the present disclosure, when the computer-readable storage medium is running to display the orientation guidance identifier on the graphical user interface in response to the virtual object moving into the target scene area, the following instructions are specifically executed:

in response to the virtual object moving into the target scene area, detecting a distance between the virtual object and the virtual supply in the target scene area; and

in response to the distance between the virtual object and the virtual supply in the target scene area being less than the preset distance threshold, displaying the orientation guidance identifier on the graphical user interface.

In an embodiment of the present disclosure, the computer-readable storage medium further executes the following instructions:

displaying a supply area identifier corresponding to the virtual supply in the map area corresponding to the target scene area in the scene thumbnail map displayed in the graphical user interface.

In an embodiment of the present disclosure, when the computer-readable storage medium is running to display the supply area identifier corresponding to the virtual supply in the map area corresponding to the target scene area in the scene thumbnail map displayed in the graphical user interface, the computer-readable storage medium specifically executes the following instructions:

overlaying and displaying the supply area identifier with a preset area corresponding to the virtual supply in the map area corresponding to the target scene area in the scene thumbnail map displayed in the graphical user interface.

In an embodiment of the present disclosure, when the computer-readable storage medium executes the step of controlling to drop the virtual supply in the virtual scene, the computer-readable storage medium executes the following instructions:

generating the virtual supply at a preset height of the virtual scene; and

controlling the virtual supply to move from the preset height to the target position of the virtual scene.

In an embodiment of the present disclosure, when the computer-readable storage medium executes the step of displaying the supply area identifier corresponding to the virtual supply in the map area corresponding to the target scene area in the scene thumbnail map displayed in the graphical user interface, the computer-readable storage medium specifically executes the following instructions:

in the process of controlling the virtual supply to move from the preset height to the target position of the virtual scene, displaying the supply area identifier corresponding to the virtual supply in the map area corresponding to the target scene area in the scene thumbnail map displayed in the graphical user interface.

In an embodiment of the present disclosure, the computer-readable storage medium also executes the following instructions:

in response to the virtual supply moving from the preset height to the target position of the virtual scene, controlling the supply area identifier to be updated to the supply location identifier displayed at the position corresponding to the target position of the scene thumbnail.

In an embodiment of the present disclosure, the computer-readable storage medium also executes the following instructions:

displaying the supply area identifiers corresponding to the virtual supplies displayed in the map areas corresponding to different target scene areas in the scene thumbnail map differently; where different target scene areas are used to drop virtual supplies of different levels.

In an embodiment of the present disclosure, the computer-readable storage medium further executes the following instructions:

displaying a timing control on the graphical user interface; where the timing control is configured to display a countdown according to the moment when the virtual supply is generated at the preset height of the virtual scene and the moment when the virtual supply moves from the preset height to the target position of the virtual scene; and

adjusting the display form of the supply area identifier corresponding to the virtual supply displayed in the map area corresponding to the target scene area in the scene thumbnail map according to the countdown displayed in the timing control.

In an embodiment of the present disclosure, when the computer-readable storage medium executes to adjust the display form of the supply area identifier corresponding to the virtual supply displayed in the map area corresponding to the target scene area in the scene thumbnail map according to the countdown displayed in the timing control, the following instructions are specifically executed:

filling the supply area identifier corresponding to the virtual supply displayed in the map area corresponding to the target scene area in the scene thumbnail map with the target color according to the time progress of the countdown displayed in the timing control; where the time progress of the countdown is correlated with the filling area of the supply area identifier, and the target color is determined according to the level of the virtual supply dropped in the target scene area.

In an embodiment of the present disclosure, the computer-readable storage medium further executes the following instructions:

displaying a virtual object identifier corresponding to the virtual object in the scene thumbnail map displayed in the graphical user interface;

where updating the position of the virtual object identifier in the scene thumbnail map in real time according to the movement of the virtual object in the virtual scene.

In an embodiment of the present disclosure, the computer-readable storage medium further executes the following instructions:

in response to the virtual supply in the target scene area being picked up, controlling the deletion of the supply area identifier corresponding to the virtual supply from the map area corresponding to the target scene area in the scene thumbnail map.

In an embodiment of the present disclosure, the preset condition includes one of the following items:

the game process of this virtual battle task reaches a preset time point;

the virtual object in this virtual battle task executes a virtual vehicle summoning event, where the virtual vehicle is configured to drop virtual supplies into the virtual scene; and

the number of surviving virtual objects in this virtual battle task reaches a set number.

According to the game control method provided by the embodiment of the present disclosure, the player can control the movement of the virtual object toward the target scene area according to the relative position between the supply area identifier and the virtual object identifier displayed in the scene thumbnail map; after the virtual object moves to the target scene area, an orientation guidance identifier is displayed on the graphical user interface to guide the virtual object to move from the current position of the virtual object toward the virtual supply. In the above manner, since there is no need to display the exact location of virtual supplies, the specific calculation of the exact location of virtual supplies can be avoided, thereby reducing the consumption of computer resources; since players cannot predict the actual location of virtual supplies in the virtual scene, the location of virtual supplies in the virtual scene has a certain degree of randomness, which can take into account the individual differences of players to improve the fairness of the game; and old players cannot squat near the location of virtual supplies in advance, which can promote more new players to compete for virtual supplies, thereby improving the development speed of new players, and since more players search for virtual supplies in a similar time period, different camps are bound to fight to eliminate some players, thereby shortening the duration of a single game; after moving to the target scene area, players can find the virtual supplies as soon as possible according to the orientation guidance identifier, which improves the speed of players searching for virtual supplies in the virtual scene, helps to shorten the duration of a single game, and improves the efficiency of human-computer interaction.

Those skilled in the art can clearly understand that for the convenience and simplicity of description, the specific working process of the system, device and unit described above can refer to the corresponding process in the aforementioned method embodiment, and will not be repeated here.

In the several embodiments provided in the present disclosure, it should be understood that the disclosed systems, devices and methods can be implemented in other ways. The device embodiments described above are only schematic. For example, the division of the units is only a logical function division. There may be other division methods in actual implementation. For example, multiple units or components can be combined or integrated into another system, or some features can be ignored or not executed. Another point is that the mutual coupling or direct coupling or communication connection shown or discussed can be through some communication interfaces, indirect coupling or communication connection of devices or units, which can be electrical, mechanical or other forms.

The units described as separate components may be or may not be physically separated, and the components displayed as units may be or may not be physical units, that is, they may be located in one place, or they may be distributed on multiple network units. Some or all of the units can be selected according to actual needs to achieve the purpose of the scheme of this embodiment.

In addition, respective functional units in embodiments of the present disclosure can be integrated into a processing unit, or respective units can exist physically separately, or two or more units can be integrated into one unit.

If the functions are implemented in the form of software functional units and sold or used as independent products, they can be stored in a non-volatile computer-readable storage medium that can be executed by a processor. Based on this understanding, the technical solution of the present disclosure, or the part that contributes to the relevant technology or the part of the technical solution, can be embodied in the form of a software product. The computer software product is stored in a storage medium and includes several instructions to enable a computer device (which can be a personal computer, server, or network device, etc.) to execute all or part of the steps of the method described in each embodiment of the present disclosure. The aforementioned storage medium includes: U disk, mobile hard disk, read-only memory (ROM), random access memory (RAM), disk or optical disk, etc., various media that can store program codes.

Finally, it should be noted that the above-described embodiments are only specific implementation methods of the present disclosure, which are used to illustrate the technical solutions of the present disclosure, rather than to limit them. The protection scope of the present disclosure is not limited thereto. Although the present disclosure is described in detail with reference to the aforementioned embodiments, those skilled in the art should understand that any technician familiar with the technical field can still modify the technical solutions recorded in the aforementioned embodiments within the technical scope disclosed in the present disclosure, or can easily think of changes, or make equivalent replacements for some of the technical features therein; and these modifications, changes or replacements do not make the essence of the corresponding technical solutions deviate from the spirit and scope of the technical solutions of the embodiments of the present disclosure, and should be included in the protection scope of the present disclosure. Therefore, the protection scope of the present disclosure shall be based on the protection scope of the claims.

1. A game control method, comprising:
providing, by a terminal device, a graphical user interface, and displaying a virtual scene of a current virtual battle task on the graphical user interface;
in response to detecting that the current virtual battle task meets a preset condition, dropping a virtual supply in the virtual scene;
determining a target scene area corresponding to the virtual supply dropped in the virtual scene; and
in response to detecting that a virtual object moves into the target scene area, displaying an orientation guidance identifier on the graphical user interface, and controlling a direction indicator of the orientation guidance identifier according to a target position of the virtual supply in the virtual scene.

2. The method according to claim 1, wherein the target position is located in the target scene area.

3. The method according to claim 2, wherein displaying the orientation guidance identifier on the graphical user interface in response to detecting that the virtual object moves into the target scene area comprises:
in response to detecting that the virtual object moves into the target scene area, detecting a distance between the virtual object and the virtual supply in the target scene area; and
in response to detecting that the distance between the virtual object and the virtual supply in the target scene area is less than a preset distance threshold, displaying the orientation guidance identifier on the graphical user interface.

4. The method according to claim 2, further comprising:
displaying a supply area identifier corresponding to the virtual supply in a map area corresponding to the target scene area in a scene thumbnail map displayed in the graphical user interface.

5. The method according to claim 4, wherein displaying the supply area identifier corresponding to the virtual supply in the map area corresponding to the target scene area in the scene thumbnail map displayed in the graphical user interface comprises:
overlaying and displaying a supply area identifier with a preset area corresponding to the virtual supply at the map area corresponding to the target scene area in the scene thumbnail map displayed in the graphical user interface.

6. The method according to claim 4, wherein dropping the virtual supply in the virtual scene comprises:
generating the virtual supply at a preset height of the virtual scene; and
controlling the virtual supply to move from the preset height to the target position of the virtual scene.

7. The method according to claim 6, wherein displaying the supply area identifier corresponding to the virtual supply in the map area corresponding to the target scene area in the scene thumbnail map displayed in the graphical user interface comprises:
during a process of controlling the virtual supply to move from the preset height to the target position of the virtual scene, displaying the supply area identifier corresponding to the virtual supply in the map area corresponding to the target scene area in the scene thumbnail map displayed in the graphical user interface.

8. The method according to claim 7, further comprising:
in response to detecting that the virtual supply moves from the preset height to the target position of the virtual scene, controlling the supply area identifier to be updated to a supply location identifier displayed at a position of the scene thumbnail corresponding to the target position.

9. The method according to claim 4, further comprising:
displaying supply area identifiers corresponding to virtual supplies displayed in map areas corresponding to different target scene areas in the scene thumbnail map differently; wherein the different target scene areas are configured to drop virtual supplies of different levels.

10. The method according to claim 7, further comprising:
displaying a timing control on the graphical user interface; wherein the timing control is configured to display a countdown according to a moment when the virtual supply is generated at the preset height of the virtual scene and a moment when the virtual supply moves from the preset height to the target position of the virtual scene; and
adjusting a display form of the supply area identifier corresponding to the virtual supply displayed in the map area corresponding to the target scene area in the scene thumbnail map according to the countdown displayed in the timing control.

11. The method according to claim 10, wherein adjusting the display form of the supply area identifier comprises:
filling the supply area identifier corresponding to the virtual supply displayed in the map area corresponding to the target scene area in the scene thumbnail map with a target color according to a time progress of the countdown displayed in the timing control; wherein the time progress of the countdown is correlated with a filling area of the supply area identifier, and the target color is determined according to a level of the virtual supply dropped in the target scene area.

12. The method according to claim 4, further comprising:
displaying a virtual object identifier corresponding to the virtual object in the scene thumbnail map displayed in the graphical user interface;
wherein a position of the virtual object identifier in the scene thumbnail map is updated in real time according to a movement of the virtual object in the virtual scene.

13. The method according to claim 4, further comprising:
in response to detecting that the virtual supply in the target scene area is picked up, controlling to delete the supply area identifier corresponding to the virtual supply from the map area corresponding to the target scene area in the scene thumbnail map.

14. The method according to claim 1, wherein the preset condition comprises one of the following items:
a game process of the current virtual battle task reaches a preset time point;
a virtual object in the current virtual battle task executes a virtual vehicle summoning event, wherein the virtual vehicle is configured to drop the virtual supply into the virtual scene; and
a number of surviving virtual objects in the current virtual battle task reaches a set number.

15. (canceled)

16. An electronic device, wherein the electronic device comprises: a processor, a memory and a bus, the memory stores machine-readable instructions executable by the processor, when the electronic device is running, the processor communicates with the memory through the bus, and by executing the machine-readable instructions, the processor is configured to:
provide a graphical user interface, and displaying a virtual scene of a current virtual battle task on the graphical user interface:
in response to detecting that the current virtual battle task meets a preset condition, control to drop a virtual supply in the virtual scene;
determine a target scene area corresponding to the dropped virtual supply in the virtual scene; and
in response to detecting that a virtual object moves into the target scene area, display an orientation guidance identifier on the graphical user interface, and control a direction indicator of the orientation guidance identifier according to a target position of the virtual supply in the virtual scene.

17. A non-transitory computer-readable storage medium, wherein a computer program is stored on the computer-readable storage medium, and when executing the computer program, the processor is configured to:
provide, by a terminal device, a graphical user interface, and display a virtual scene of a current virtual battle task on the graphical user interface;
in response to detecting that the current virtual battle task meets a preset condition, control to drop a virtual supply in the virtual scene;
determine a target scene area corresponding to the dropped virtual supply in the virtual scene; and
in response to detecting that a virtual object moves into the target scene area, display an orientation guidance identifier on the graphical user interface, and control a direction indicator of the orientation guidance identifier according to a target position of the virtual supply in the virtual scene.

18. The method according to claim 5, wherein a ratio of the occupied area of the supply area identifier in the scene thumbnail map to a total area of the scene thumbnail map is equal to a preset ratio threshold, wherein the preset ratio threshold is determined according to a ratio of an actual area of the target scene area to an area of the entire virtual scene.

19. The method according to claim 4, wherein the supply area identifier is overlaid on the map area in a semi-transparent form.

20. The method according to claim 9, wherein display form of the differentiated display includes at least one of the following items: display brightness, display shape, filled color and filled pattern.

21. The method according to claim 12, further comprising:
displaying virtual object identifiers corresponding to multiple other virtual objects which belong to a same camp with the virtual object; and
in response to detecting that the virtual object is eliminated, deleting the virtual object identifier corresponding to the virtual object from the scene thumbnail map.
